(19) United States
(12) Patent Application Publication
(10) Pub. No.: US 2019/0284865 A1
(43) Pub. Date: Sep. 19, 2019

(54) REINFORCED INSULATING GLASS UNIT

(71) Applicant: AGC GLASS EUROPE, Louvain-La-Neuve (BE)

(72) Inventors: Olivier BOUESNARD, Ittre (BE); Nicolas CHORINE, Court-Saint-Etienne (BE); Julien JEANFILS, Thorembais-St-Trond (BE)

(73) Assignee: AGC GLASS EUROPE, Louvain-La-Neuve (BE)

(21) Appl. No.: 16/334,911

(22) PCT Filed: Aug. 28, 2017
(86) PCT No.: PCT/EP2017/071532

§ 371 Date: Mar. 20, 2019

(30) Foreign Application Priority Data
Sep. 23, 2016 (EP) 16002054.1

(51) Int. Cl. E06B 3/02; E06B 3/66; E06B 3/663

(52) U.S. Cl. CPC E06B 3/025; E06B 3/66342; E06B 3/6612

(57) ABSTRACT

Insulating glass unit (IGU) comprising at least two glass plates and at least one reinforcing element that increases the bending stiffness of at least a part of the IGU, and glass doors or windows comprising said IGU.

The invention relates to an insulating glass unit (IGU) comprising glass plates and a reinforcing element to avoid an excessive bending of the glass plates and, more particularly, to an insulating glass unit comprising at least two glass plates and a reinforcing element connected by a structural sealant. The invention also relates to glass doors or windows comprising the IGU.

The IGUs for doors or windows are usually provided for obturating openings in a building. These insulating glass units should withstand wind, namely they should bend without breaking. However, the deflection or bending of the glazing must not exceed a certain threshold. To avoid excessive bending of the glass plates, there are already different known solutions.

At first, increasing the thickness of the glass plates leads to a stiffening of the glazing. However, it also leads to an increase of the glazing weight causing drawbacks such as difficulties during positioning, or the increase of stresses in the seals. It is particularly a problem for non-supported glazings.

Another solution is to stiffen only the edges of the glass plates as disclosed by patent document CH703832B1. Such IGU comprises at least two glass plates which are kept apart by spacers. The stiffness is improved by a profile fixedly connected to the glass plates at their edges. This common profile can extend peripherally along the outer rim of the two glass plates or be located between the two glass plates. In this way, the glass plates together with the profile form an IGU with an improved stiffness.

The insulating glass unit of said prior art reference has the drawback of requiring one expensive additional step to the manufacturing process. The manufacturing efficiency is impacted because the profile has to be fixed to the glass plates with a hardenable adhesive which is expensive and requires some time and plant space to harden. Also, there is a risk of chemical incompatibility between the particular adhesive and the IGU sealants.

In addition, the profile width has to be adapted for different IGUs depending on the distance between the glass plates. This solution hence lacks universality.

It is an objective of the present invention to remedy the drawbacks of the aforementioned prior art.

It is hence an objective of the present invention to provide an IGU with an improved stiffness without significant weight increase and consequently without significant impact on the stresses in the sealants and without impacting significantly the handling of such IGU.

It is another objective of the present invention to provide IGUs comprising a universal reinforcing element, i.e. the width of the reinforcing element has not to be adjusted to the distance between the glass plates of each given IGU, or said otherwise, reinforcing elements of a same width can stiffen IGUs with different spacer widths.

It is also an objective of the invention in at least one of its embodiments to provide an IGU which improves the stiffness of the unit while facilitating the manufacturing process to reduce costs. The IGU according to the invention permits the use of a single sealant to fasten the reinforcing element and to fix the two glass plates together. In this way, the expensive additional step of the aforementioned prior art is avoided. The manufacturing process is faster because the particular adhesive is not used anymore and it is not necessary to wait while this adhesive is hardening. Also, the risk of chemical incompatibility between the adhesive and the IGU sealants is removed.

It is another objective of at least one embodiment of the invention to provide reinforced IGUs that have a small gap between the glass plates, i.e. below 12 mm, such that the reinforcing element can advantageously be fully embedded between the glass plates. The visual impact of the introduction of the reinforcing element is hence minimal.

To this end, the invention relates to an insulating glass unit (IGU) comprising:
at least two glass plates connected by a structural sealant and,
at least one reinforcing element at least partially embedded between the glass plates and connected to said glass plates through the structural sealant, characterized in that
   said reinforcing element is such that it increases the bending stiffness of at least a part of the IGU and,
   said reinforcing element is separated from at least one of the glass plates by a space filled up with a non-structural element.

By insulating glass unit (IGU), it is meant any assembly of at least two glass plates which reduces heat exchange from one side of the glazing to the other side. The glass plates are separated from each other and secured together by at least a sealing means. Usually, the glass plates will also be separated from each other by at least a spacer which generally runs around between the glass plates, and which may be filled with a desiccative material. The sealing means can be of various types, typically polysulfide, polyurethane or silicone. The interspace defined between glass sheets and spacer is usually filled with dry air or an inert gas, such as argon or krypton, or by a mixture of them to reduce the heat exchange. The IGU of the present invention is preferably a double or a triple glazing.

Glass plates will be chosen among all known glass technologies, among them: float clear, extra-clear or coloured glass, optionally with a low-emissivity or a solar control coating, optionally tempered and/or laminated, glass products with dynamic properties, so-called active glass, such as electro-chromic glass, at least partially painted glass, at least partially enameled glass and combinations thereof. The glass plates can have the same or different dimensions.

A structural sealant here designates an elastic sealant having the ability to transfer dynamic or static loads or both across joint members exposed to the service environments such as the weight of the glass plates, the thermal dilatation or contraction, the wind or the like.

In the present invention, the structural sealant connects the glass plates together and with the reinforcing element. It contributes to the tightness of the IGU (water vapor and insulating gas). It extends along the whole perimeter of the IGU. The structural sealant can be of various types, typically polysulfide, polyurethane or silicone, preferably silicone.

The reinforcing element is an element that increases the bending stiffness of at least a part of the IGU. Bending stiffness is known in mechanics to be a function of the Young modulus of the material and of the moment of inertia. Making use of a material with a high Young modulus and/or increasing the moment of inertia will hence lead to increase the bending stiffness. The moment of inertia is a physical quantity that characterizes the geometry of masses of a solid, that is to say, the distribution of matter inside of it. Besides, for a beam of rectangular section such as a reinforcing element of rectangular section, the moment of inertia is known to be proportional to the height of the section and to its width to the third. For more complex shapes, the relationship is more complex, but the width of the element remains a prominent factor to increase the moment of inertia.

In the present invention, stiffness and bending stiffness will be used in the rest of the text interchangeably.

The effect brought by the reinforcing element is hence achieved by its geometry, its position in the IGU, its nature or a combination thereof.

Therefore, the reinforcing element generally has a Young modulus greater or equal to the one of the structural sealant. Examples of materials suitable to make the reinforcing element and having a Young modulus greater or equal to the one of the structural sealant are metals, polymers, ceramics or composite materials like carbon or glass fibers reinforced polymers. The reinforcing element preferably has a Young modulus greater or equal to the one of the structural sealant and has a thermal expansion coefficient close to that of glass such as glass fibers reinforced polymers.

The reinforcing element is generally a profile, i.e. a product having a constant section and a length proportionally greater than its section. The section can have any shape known to the skilled person. Its dimensions are as large as possible to increase as much as possible the moment of inertia, but are limited by the configuration of the IGU or the applications in which it is used. For instance, the width of the reinforcing element is limited by the space available between the glass plates, its height inside the glazing is limited by the acceptable visual impact on the transparent area.

Stress concentration might occur in the structural sealant in the vicinity of the contact zone between the reinforcing element, the structural sealant and the space between said element and a glass plate. In order to avoid or reduce this phenomenon, the edge of the reinforcing element in this zone is preferably beveled or rounded. When several said contact zones are present in the IGU, the different edges of the reinforcing elements in the vicinity of these zones are similarly beveled or rounded. To ease the manufacturing of the reinforcing element, it might be that other edges of the reinforcing element are similarly beveled or rounded.

The reinforcing element can be plain, hollow, open (U-shaped), perforated or a mix of these structures along the length of the element.

It extends at least partially along the edges of the IGU. It can be a continuous element or be made of several portions contiguous or not. It is preferably a continuous element extending along the whole perimeter of the IGU, which brings a higher moment of inertia when compared to discontinuous elements and is easier to install.

The reinforcing element is at least partially embedded between the glass plates and connected to the glass plates through the structural sealant.

In an embodiment according to the invention, the reinforcing element is totally embedded between the glass plates. This embodiment is particularly advantageous for applications where a glassy look is a key feature such as for frameless doors or windows.

In another embodiment according to the invention, the reinforcing element protrudes over at least one of the glass plates. This particular embodiment allows further stiffening of the IGU as the height and width of the protruding portion of the element are no more limited by the space available between the glass plates. An example is a stepped IGU where the glass plates have different dimensions. In such case, the reinforcing element protrudes over a smaller glass plate and does not protrude over a bigger glass plate.

In the present invention, the reinforcing element is separated from at least one of the glass plates by a space filled up with a non-structural element.

By non-structural element is meant an element that does not have the ability to transfer dynamic or static loads or both across joint members exposed to the service environments such as the weight of the glass plates, the thermal dilatation or contraction, the wind or the like.

In the configuration of the prior art, a structural adhesive and the reinforcing element are present in the space between the glass plates. The structural adhesive must be large enough to avoid breakage of the structural adhesive when the glazing is under loading as known by the one skilled in the art on the basis of the properties of the IGU and stresses inside the IGU. In consequence, the reinforcing element of the art has a limited width and provides a limited stiffness improvement.

In the present invention, the replacement of the structural adhesive by a non-structural element allows having a reinforcing element with a larger width. Indeed, stresses remain low within a non-structural element and the risk of breakage is avoided. Therefore, a small width of non-structural element can be used allowing for the presence of a larger reinforcing element between the glass plates providing increased stiffness improvement

The non-structural element comprises air and/or a non-structural material and/or a non-adhesive piece. When different non-structural elements are used to fill the space, said space comprises sub-spaces each comprising one of the non-structural element. When different non-structural elements are used and air is one of them, air is located in the sub-space in contact with the exterior of the glazing. In such cases, the sub-space filled by air may have a drip groove function. The function of a drip groove is to avoid the run off of water or condensate through the door or window. In such cases, the sub-space may also be free to receive other elements such as preformed gaskets suitable for water and air tightness of the door or window.

Non-structural materials suitable in the present case are for instance non hardenable adhesives such as polyisobutylene or butyle sealant; foams; double sided foam adhesives. These materials are significantly more flexible than the structural sealant. An example of non-adhesive piece is a Teflon® piece. The non-adhesive piece can be a permanent piece of the IGU or can be removed at a certain moment of the IGU life. The hardenable adhesive of the prior art is not used anymore and it is not necessary to wait while this adhesive is hardening. It allows a faster manufacturing process.

In another particular embodiment of the invention, there is a space filled up with a non-structural element on both sides of the reinforcing element. In other words, the reinforcing element is separated from two neighbouring glass plates on each side by a space filled up with a non-structural element. In this embodiment, the reinforcing element can have the maximum width between two adjacent glass plates what is advantageous to improve the stiffness of the glazing.

In the particular case where the IGU is a triple IGU, the at least one reinforcing element can be located between any couple of glass plates. At least one reinforcing element can also be located between each couple of glass plates. The at least one reinforcing element is separated from at least one of the glass plates by a space filled up with a non-structural element, said at least one glass plate can be any of the external or the internal glass plate of the triple glazing.

The present invention also relates to a glass door or window comprising the IGU according to the invention.

The IGU according to the invention is particularly interesting for frameless glass doors or windows. By frameless glass door or window, it is meant that the casement of the door or window has a higher transparent area than a standard one by elimination of some or all the frame elements of the casement. The reinforcing element of the IGU advantageously provides stiffness to the door or window in the absence of such frame elements. The frameless glass door or window preferably comprises an IGU comprising at least a reinforcing element totally embedded between the glass plates. The reinforcing element does not protrude over the glass plates and does not alter the aesthetics of the door or window what is important in this type of application where a glassy look is key.

A particular example of frameless glass door or window is a multiple sashes glass door or window comprising at least two contiguous sashes having no mullion between the contiguous sashes, and at least one of said sashes comprises an IGU according to the invention. It means that all the sashes may comprise IGUs according to the invention or that at least one of them comprises an IGU according to the invention and at least another one comprises a conventional IGU. The at least one reinforcing element of the IGU according to the invention preferably extends substantially along at least one of the IGU edges that is contiguous with another sash. It means that the at least one reinforcing element extends along the whole edge or partially along the edge that is contiguous to another sash. The location of the reinforcing element at this edge advantageously stiffens the multiple sashes glass door or window in the absence of mullions between contiguous sashes.

Another particular example of frameless glass door or window is a ribbon window comprising at least two contiguous IGUs having no mullion between the contiguous IGUs, and at least one of said IGUs is an IGU according to the invention. It means that all the IGUs of the ribbon window may be IGUs according to the invention or that at least one of them is an IGU according to the invention and at least another one is a conventional IGU. The at least one reinforcing element of the IGU according to the invention preferably extends substantially along at least one of the IGU edges that is contiguous with another IGU. It means that the at least one reinforcing element extends along the whole edge or partially along the edge that is contiguous to another IGU. The location of the reinforcing element at this edge advantageously stiffens the ribbon window in the absence of mullions between contiguous IGUs.

The present invention also relates to a process for the manufacturing of the IGU of the invention. An IGU is generally produced according to a method comprising the steps of:
Cleaning of the glass plates
Positioning and fastening of the spacer
Assembly of the glass plates and spacer
Injection of the sealant.

Optionally, said process comprises the injection of an inert gas, such as argon or krypton, or by a mixture of them.

The process for the manufacturing of the IGU according to the present invention comprises an additional step of introduction of the reinforcing element and the injected sealant is a structural sealant. The step of introduction of the reinforcing element can take place at any moment after the cleaning of the glass plates. It can for instance take place before the assembly of the glass plates or even before the positioning and fastening of the spacer. It can alternatively take place before the assembly of the glass plates and after the positioning and fastening of the spacer. It can also take place after the assembly of the glass plates and before the injection of the structural sealant or even after the injection of the structural sealant. When the reinforcing element is a preformed continuous element extending along the whole perimeter of the IGU, it is introduced at any moment before the assembly of the glass plates.

The invention will be better understood upon reading the following description in view of the attached figures, wherein:

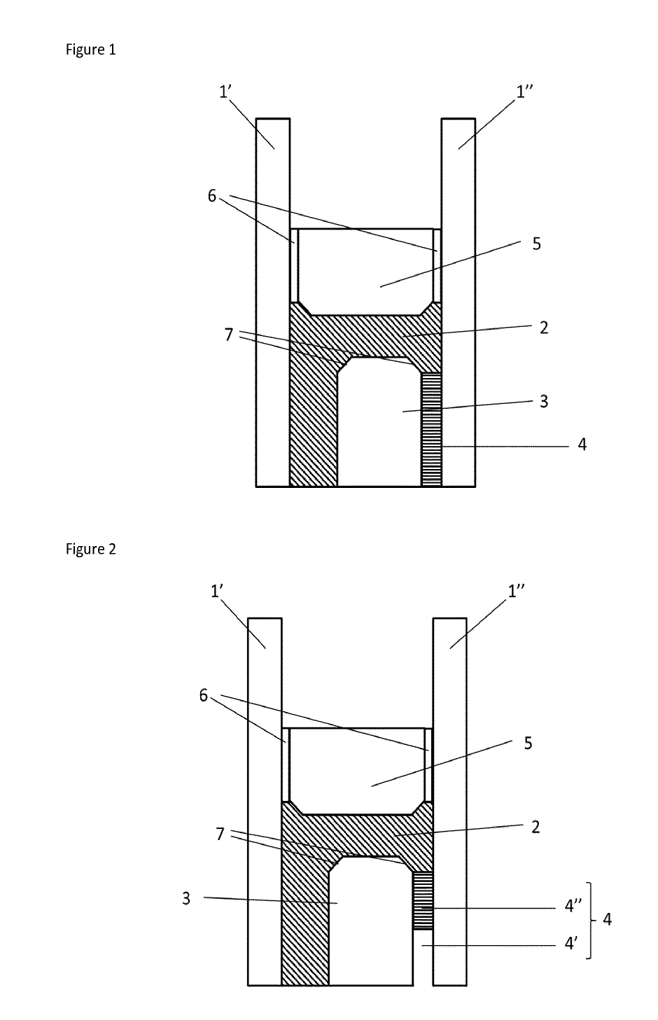

FIG. 1 shows a cross-sectional view of a first embodiment of the IGU of the invention, with two glass plates;

FIG. 2 shows a cross-sectional view of a second embodiment of the IGU of the invention, with two glass plates;

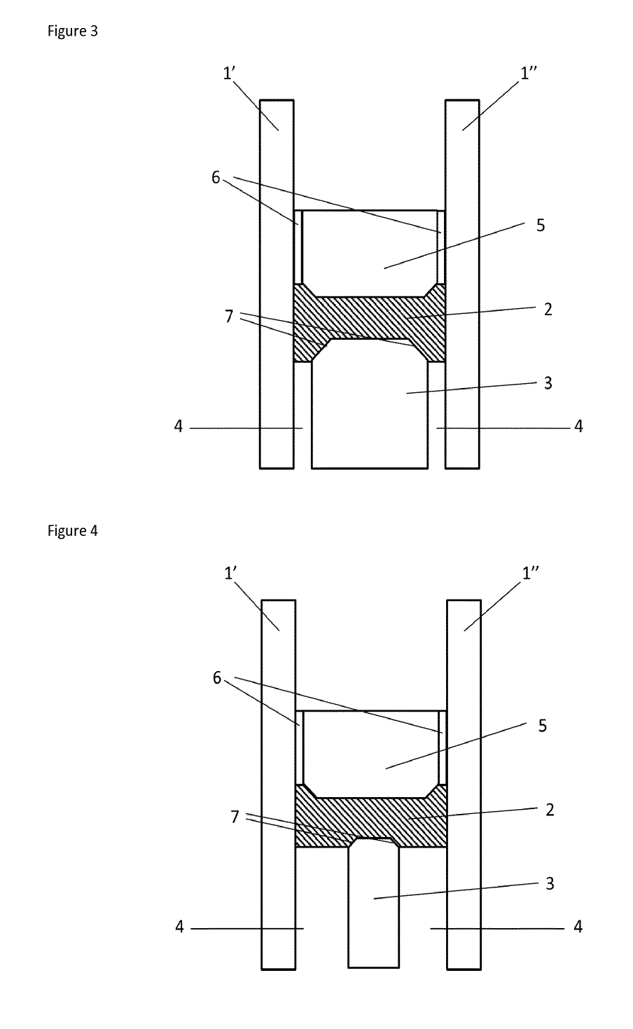

FIG. 3 shows a cross-sectional view of a third embodiment of the IGU of the invention, with two glass plates;

FIG. 4 shows a cross-sectional view of another configuration of the embodiment of FIG. 3 of the IGU of the invention, with two glass plates;

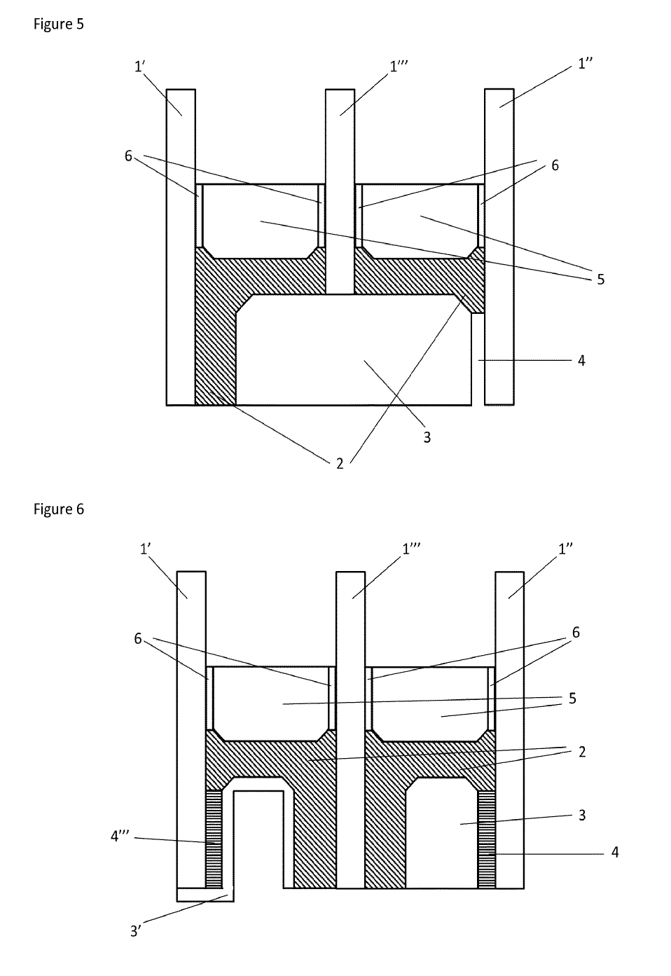

FIG. 5 shows a cross-sectional view of a fifth embodiment of the IGU of the invention, with three glass plates;

FIG. 6 shows a cross-sectional view of a sixth embodiment of the IGU of the invention, with three glass plates.

In reference to FIG. 1, which represents one edge of the insulating glass unit, the IGU is a double glazing with two glass plates 1′ and 1″. The glass plates 1′ and 1″ are connected to each other by a structural sealant 2. The two glass plates 1′ and 1″ are spaced apart by a spacer 5 fastened to the glass plates by two sealants 6 as in any conventional IGU. A reinforcing element 3 is here totally embedded between the two neighbouring glass plates 1′ and 1″ and connected to them through the structural sealant 2. It has a beveled edge 7 in the vicinity of the contact area between the reinforcing element 3, the structural sealant 2 and the space 4 and a second beveled edge facing the first one. A space 4 filled with a double sided foam adhesive is provided between the reinforcing element 3 and glass plate 1″.

The embodiment of FIG. 2 of the IGU of the invention comprises almost all the same technical elements as the embodiment of FIG. 1, with the same reference numbers. In this embodiment, the space 4 comprises a sub-space 4″ filled with a double sided foam adhesive and a sub-space 4′ filled with air.

The embodiment of FIG. 3 of the IGU of the invention comprises also almost the same technical elements as the embodiment of FIG. 1, with the same reference numbers. In this embodiment, a space 4 filled with air is present on both sides of the reinforcing element 3, which has a large width, thereby providing a significant bending stiffness improvement.

FIG. 4 illustrates another configuration of the embodiment of FIG. 3 where the space 4 present on both sides of the reinforcing element 3 is larger and the reinforcing element 3 narrower thereby providing a lower bending stiffness improvement compared to the configuration of FIG. 3.

The embodiment of FIG. 5 represents a triple glazing, with two external glass plates 1′ and 1″ and a shorter internal glass plate 1′″. The glass plates are spaced apart by two spacers 5 fastened to the glass plates by sealants 6. Each external glass plate 1′, 1″ is connected to the internal glass plate 1′″ by a structural sealant 2. A large single reinforcing element 3 is located between the glass plates 1′ and 1″ and is connected to them by the structural sealant 2. A space 4 filled with air is provided between the reinforcing element 3 and the glass plate 1″.

The embodiment of FIG. 6 represents another triple glazing comprising almost all the same technical elements as the embodiment of FIG. 5, with the same reference numbers. The two external glass plates 1′ and 1″ and internal glass plate 1′″ have the same dimensions. They are spaced apart by two spacers 5 fastened to the glass plates by sealants 6. Each external glass plate 1′, 1″ is connected to the internal glass plate 1′″ by a structural sealant 2. The reinforcing element 3′ located between the glass plates 1′ and 1′″ is hollow and protrudes over the glass plate 1′. It is separated from the glass plate 1′ by a space 4 filled with a double sided foam adhesive. The reinforcing element 3 located between the glass plates 1′″ and 1″ is plain and totally embedded between the glass plates. It is separated from the glass plate 1″ by a space 4 filled with a double sided foam adhesive.

The table below gives values of the deflection of the edge of three IGUs having different reinforcement configurations, when this edge is submitted to a linear load.

Each of the three IGUs comprises two glass plates with a thickness of 6 mm, a spacer with a thickness of 18 mm, and a structural sealant, namely DC 3362 silicone from Dow Corning, with a height of 6 mm. The first IGU is a conventional IGU without reinforcing element. The second IGU corresponds to the configuration illustrated in FIG. 4. Compared to first IGU, it comprises a reinforcing element all along the loaded edge, and this reinforcing element has a height of 6 mm, a width of 6 mm and a Young modulus equivalent to glass. The reinforcing element is separated from both glass plates by a space with a width of 6 mm filled with air. The third IGU corresponds to the configuration illustrated in FIG. 3. It also comprises a reinforcing element all along the loaded edge, and this reinforcing element has a height of 6 mm, a width of 12 mm and a Young modulus equivalent to glass. Compared to the second IGU, the reinforcing element is separated from both glass plates by a space with a width of 3 mm filled with air.

For the three IGUs, the loaded edge is 2 m long and the linear load is 9.6 N/mm. The deflection is measured at the centre of the loaded edge, perpendicularly to the glass plate plan.

| | Deflection of | Distance between the | Width of the |
|---|---|---|---|
| | the edge of | reinforcing element and | reinforcing |
| | the glazing | the glass plates | element |
| Double glazing | 9.94 mm | — | — |
| without | | | |
| reinforcing | | | |
| element | | | |
| Double glazing of | 8.66 mm | 6 mm | 6 mm |
| FIG. 4 with | | | |
| reinforcing | | | |
| element | | | |
| Double glazing of | 5.27 mm | 3 mm | 12 mm |
| FIG. 3 with | | | |
| reinforcing | | | |
| element | | | |

This table shows that the reinforced IGUs according to the invention have a higher bending stiffness than an IGU without reinforcing element as demonstrated by lower deflection values. In addition, the third IGU comprising a reinforcing element with a larger width provides a higher stiffness increase.

1. An insulating glass unit (IGU) comprising:
at least two glass plates connected by a structural sealant and,
at least one reinforcing element at least partially embedded between the glass plates and connected to said glass plates through the structural sealant,
wherein
said reinforcing element is such that it increases a bending stiffness of at least a part of the IGU and,
said reinforcing element is separated from at least one of the glass plates by a space filled up with a non-structural element.

2. The insulating glass unit (IGU) according to claim 1, wherein the reinforcing element has a Young modulus greater or equal to a Young modulus of the structural sealant.

3. The insulating glass unit (IGU) according to claim 1, wherein an edge of the reinforcing element in a vicinity of a contact zone between the reinforcing element, the structural sealant and the space between said element and one of the glass plates is beveled or rounded.

4. The insulating glass unit (IGU) according to claim 1, wherein the reinforcing element is totally embedded between the glass plates.

5. The insulating glass unit (IGU) according to claim 1, wherein the reinforcing element protrudes over at least one of the glass plates.

6. The insulating glass unit (IGU) according to claim 1, wherein the non-structural element filling the space comprises air and/or a non-structural material and/or a non-adhesive piece.

7. The insulating glass unit (IGU) according to claim 6, wherein the non-structural element filling the space comprises air in a sub-space in contact with an exterior of the glazing.

8. The insulating glass unit (IGU) according to claim 7, wherein the sub-space comprises at least one preformed gasket.

9. The insulating glass unit (IGU) according to claim 1, wherein a space filled up with a non-structural element is present on both sides of the reinforcing element.

10. The insulating glass unit (IGU) according to claim 1, wherein the IGU is a double or triple glazing.

11. A glass door or window comprising at least one insulating glass unit (IGU) according to claim 1.

12. The glass door or window according to claim 11, wherein the glass door or window is a frameless glass door or window.

13. A frameless glass door or window according to claim 12, wherein the frameless glass door or window is a multiple sashes glass door or window comprising at least two contiguous sashes having no mullion between the contiguous sashes.

14. A frameless glass door or window according to claim 12, wherein the frameless glass door or window is a ribbon window comprising at least two contiguous IGUs and having no mullion between the contiguous IGUs.
